(19) United States
(12) Patent Application Publication
(10) Pub. No.: US 2004/0146042 A1
(43) Pub. Date: Jul. 29, 2004

(54) Mobile communication system and method capable of allowing shortest communications path

(76) Inventors: Yousuke Ideshita, Tokyo (JP); Toshiaki Yagami, Tokyo (JP); Toshikazu Maruyama, Tokyo (JP); Tomoya Arai, Tokyo (JP); Satoko Fukushi, Tokyo (JP); Kouki Hayashi, Tokyo (JP)

Correspondence Address: OSTROLENK FABER GERB & SOFFEN, 1180 AVENUE OF THE AMERICAS, NEW YORK, NY, 100368403

(21) Appl. No.: 10/753,576

(22) Filed: Jan. 8, 2004

(30) Foreign Application Priority Data
Jan. 8, 2003 (JP) 2003-001644

(51) Int. Cl. H04J 3/24

(52) U.S. Cl. 370/349

(57) ABSTRACT

In a mobile communication system including a home Mobile-IPv6 network for allocating a home address as a permanent address to a mobile node, a foreign Mobile-IPv6 network for allocating a care-of address to the mobile node, and at least one network including a stationary correspondent node not implementing Mobile-IPv6, a location supervising module stores the home address and said care-of address of the mobile node when the mobile node is away from the home Mobile-IPv6 network to the foreign Mobile-IPv6 network. An IP address translating module is provided for translation of an IP address between IPv6 and a protocol other than IPv6.

### BACKGROUND OF THE INVENTION

1. Field of the Invention

The present invention relates to a mobile communication system and method capable of allowing the shortest communications path between a mobile node implementing Mobile Internet Protocol version 6 (Mobile-IPv6) and a stationary correspondent node not implementing Mobile-IPv6.

2. Description of the Related Art

Generally, in a communication system including a plurality of networks (links) connected to the Internet, Mobile-IPv6 allows a mobile node to move from its home network (link) to another network (link) without changing its home address, which obtains the shortest communications path between the mobile node and a correspondent node with which the mobile node is communicating.

Note that a home address is assigned to a mobile node used as the permanent address thereof. Therefore, each mobile node is always identified by its home address regardless of its current location. Also, the above-mentioned network (link) other than the mobile node's home network (link) is called a foreign network (link).

That is, in Mobile-IPv6, when a mobile node is away from its home network (link) and connected to a foreign network (link), a care-of address for indicating the mobile node's current location is given to the mobile node. As a result, any Mobile-IPv6 packets destined to the mobile node are routed directly to it at this care-of address.

In the above-described communication system, however, the mobile node and the correspondent node need to implement Mobile-IPv6, i.e., the networks (links) to which the mobile node and the correspondent node need to belong to are Mobile-IPv6 networks (links).

Recently, although the number of networks connected to the Internet implementing Mobile-IPv6 has been increased, there are still a large number of networks connected to the Internet that are not implementing Mobile-IPv6, i.e., there are still a large number of networks implementing IPv6 and IPv4. Therefore, a mobile communication system between a Mobile-IPv6 mobile node and an IPv6 stationary correspondent node or a mobile communication between a Mobile-IPv6 mobile node and an IPv4 stationary correspondent node is required.

A first prior art mobile communication system between a Mobile-IPv6 mobile node and an IPv6 (or IPv4) stationary correspondent node is a so-called triangular communication system where, when a mobile node is moved from its home network (link) to a foreign network (link), packets from a stationary correspondent node to the mobile node are intercepted and encapsulated by a home agent on the mobile node's home network (link), and then the home agent tunnels the encapsulated packets to the foreign network (link).

In the above-described first prior art mobile communication system, however, the shortest communication path cannot be realized, which increases the load of the mobile node's home agent and also increases congestion at the mobile node's home agent.

In a second prior art mobile communication system between a Mobile-IPv6 mobile node and an IPv6 (or IPv4) stationary correspondent node, a router of a network (link) to which the IPv6 (IPv4) stationary correspondent node belongs forms IPv6 extension headers in packets destined to the Mobile-IPv6 node, encapsulates them, and then tunnels them to the care-of address of the mobile node (see: JP-A-2002-185520). Thus, since use is made of a triangular communication, the shortest communications path can be realized.

In the above-described second prior art mobile communication system, however, since the router of a network (link) to which an IPv6 (or IPv4) node belongs must be modified, the manufacturing cost would be increased.

### SUMMARY OF THE INVENTION

It is an object of the present invention to provide a mobile communication system and method capable of allowing the shortest communications path between a Mobile-IPv6 mobile node and a stationary correspondent node not implementing Mobile-IPv6 without modifying the router of a network (link) to which the stationary correspondent node belongs.

According to the present invention, in a mobile communication system including a home Mobile-IPv6 network for allocating a home address as a permanent address to a mobile node, a foreign Mobile-IPv6 network for allocating a care-of address to the mobile node, and at least one network including a stationary correspondent node not implementing Mobile-IPv6, a location supervising module stores the home address and the care-of address of the mobile node when the mobile node is away from the home Mobile-IPv6 network and connected to the foreign Mobile-IPv6 network. An IP address translating module is provided for translation between an IP address between IPv6 and a protocol other than IPv6.

### BRIEF DESCRIPTION OF THE DRAWINGS

The present invention will be more clearly understood from the description set forth below, with reference to the accompanying drawings, wherein:

FIG. 1 is diagram illustrating an embodiment of the mobile communication system according to the present invention;

FIG. 2A is a format diagram illustrating one Mobile-IPv6 packet;

FIG. 2B is a format diagram illustrating one IPv6 packet;

FIG. 2C is a format diagram illustrating one IPv4 packet;

FIG. 3 is a sequence diagram for explaining the operation of the system between the Mobile-IPv6 node and the IPv6 node of FIG. 1 while the Mobile-IPv6 node is on the home network (link);

FIGS. 4A and 4B are sequence diagrams for explaining the operation of the system between the Mobile-IPv6 node and the IPv6 node of FIG. 1 while the Mobile-IPv6 node is on the foreign network (link);

FIGS. 5A and 5B are sequence diagrams for explaining the operation of the system between the Mobile-IPv6 node and the IPv4 node of FIG. 1 while the Mobile-IPv6 node is on the home network (link);

FIGS. 6A and 6B are sequence diagrams for explaining the operation of the system between the Mobile-IPv6 node and the IPv4 node of FIG. 1 while the Mobile-IPv6 node is on the foreign network (link); and

FIG. 7 is a diagram illustrating a modification of the mobile communication system of FIG. 1.

### DESCRIPTION OF THE PREFERRED EMBODIMENT

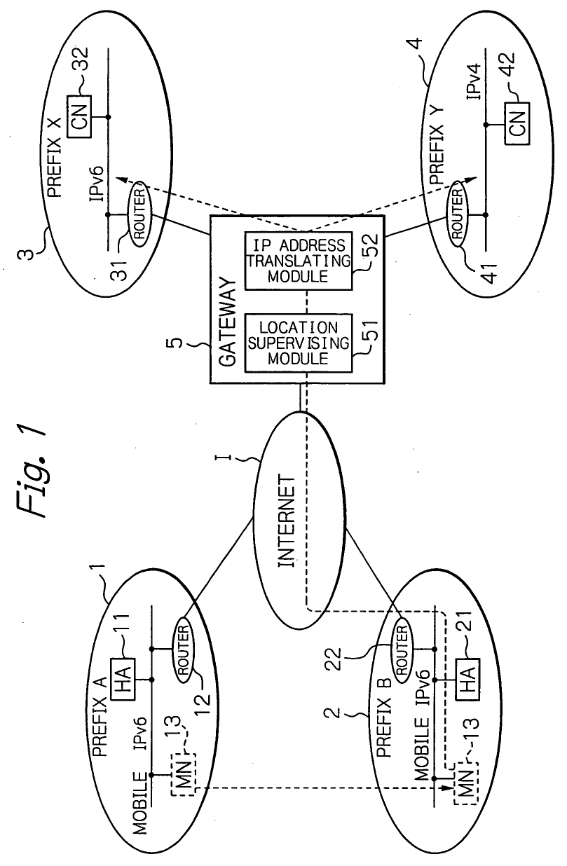

In FIG. 1, which illustrates an embodiment of the mobile communication system according to the present invention, Mobile-IPv6 networks (links) 1 and 2 are connected directly to the Internet I, while an IPv6 network (link) 3 and an IPv4 network (link) 4 are connected via a gateway 5 to the Internet I.

The Mobile-IPv6 network (link) 1 includes a home agent 11, a router 12 connected to the Internet I, and a mobile node 13. In this case, the mobile node 13 is given by a home address as a permanent address. While the mobile node 13 is away from the network (link) 1 and connected to the network (link) 2 which is called a foreign network (link), a care-of address for indicating a current location of the mobile node 13 is given thereto.

The Mobile-IPv6 network (link) 2 includes a home agent 21 and a router 22 connected to the Internet I in the same way as in the Mobile-IPv6 network 1.

The IPv6 network 3 includes a router 31 connected the gateway 5, and a stationary correspondent node 32. Also, the IPv6 network 4 includes a router 41 connected to the gateway 5 and a stationary correspondent node 42.

The gateway 5 includes a location supervising module 51 for storing location relationship information between a home address and care-of address of each mobile node and an IP address translating module 52 for translation of an IP address between IPv6 and IPv4.

In FIG. 1, prefixes A, B, X and Y are allocated to the networks 1, 2, 3 and 4, respectively. Particularly, the prefix Y is called a subnet prefix.

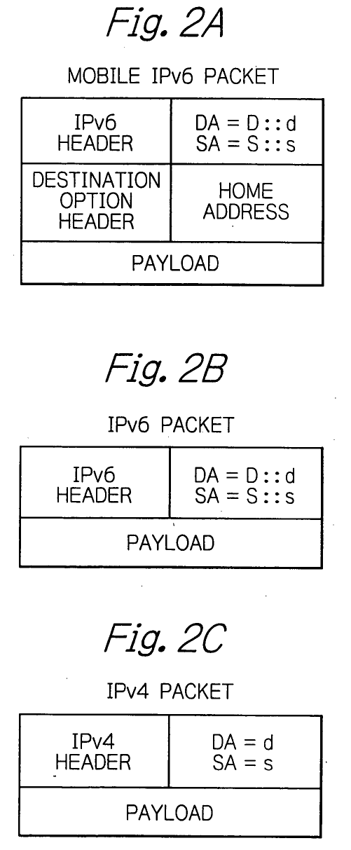

Packets of Mobile-IPv6, IPv6 and IPv4 are illustrated in FIGS. 2A, 2B and 2C, respectively.

As illustrated in FIG. 2A, one Mobile-IPv6 packet is formed by an IPv6 header including a destination address DA having a prefix such as D and a source address SA having a prefix such as S, a destination option header including a home address, and a payload.

Also, as illustrated in FIG. 2B, one IPv6 packet is formed by an IPv6 header including a destination address DA having a prefix such as D and a source address SA having a prefix such as S, and a payload.

Further, as illustrated in FIG. 2C, one IPv4 packet is formed by an IPv4 header including a destination address DA having no prefix and a source address SA having no prefix, and a payload.

Note that, when the Mobile-IPv6 mobile node 13 remains in the home network (link) 1, Mobile-IPv6 packets from and to the Mobile-IPv6 mobile node 13 are IPv6 packets as illustrated in FIG. 2B. In other words, only when the Mobile-IPv6 mobile node 13 is away from the home network (link) 1 and connected to the foreign network (link)2, Mobile-IPv6 packets from and to the Mobile-IPv6 mobile node 13 are Mobile-IPv6 packets as illustrated in FIG. 2A.

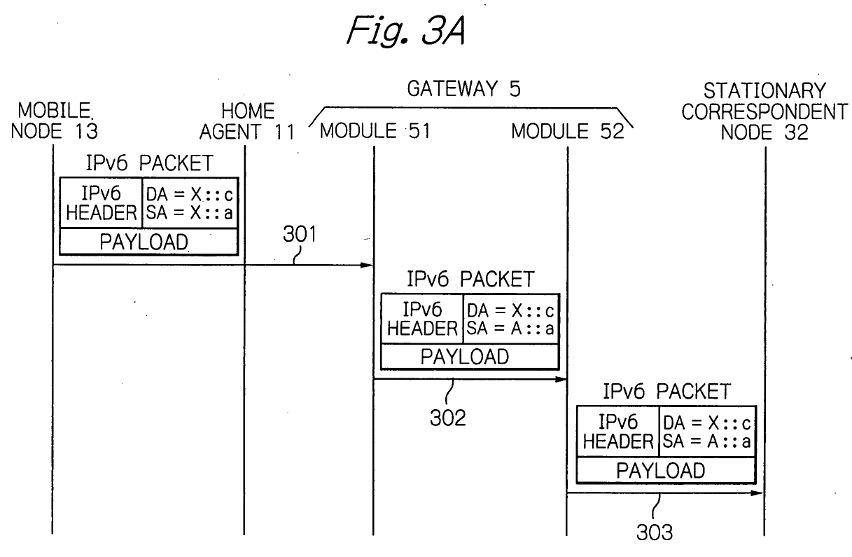

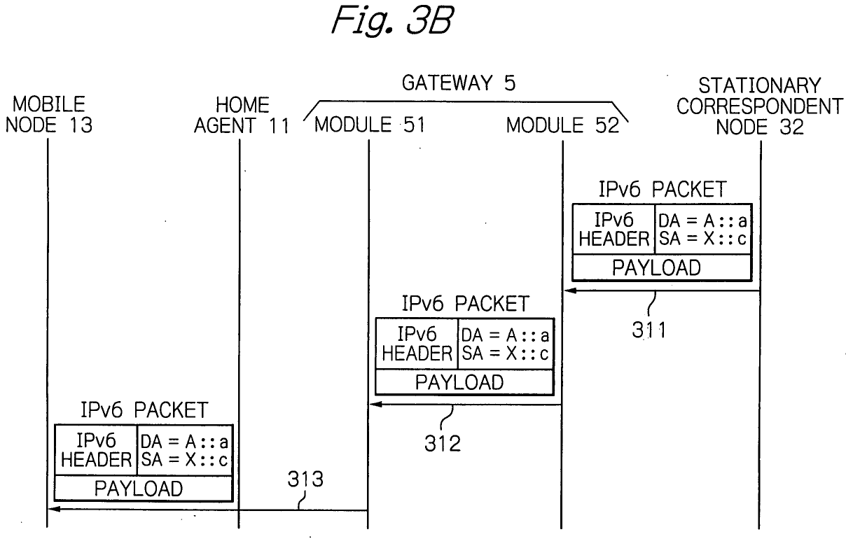

A communication from the mobile node 13 at the home network (link) 1 to the stationary correspondent node 32 will be explained next with reference to FIG. 3A. Here, assume that an IPv6 address “A::a” is allocated as a home address to the mobile node 13 and an IPv6 address “X::c” is allocated to the stationary correspondent node 32. In this case, “::” indicates some number of successive bits “0”.

First, at step 301, the mobile node 13 obtains the IPv6 address “X::c” of the stationary correspondent node 32 from a domain name system (DNS) server (not shown), and then transmits an IPv6 packet associated with an IPv6 header having a destination address “X::c” and a source address “A::a” to the location supervising module 51.

Next, at step 302, since the mobile node 13 remains in the home network (link) 1 so that the location supervising module 51 has no location relationship information of the mobile node 13, the location supervising module 51 does not intercept the IPv6 packet from the mobile node 13, i.e., transmits it without modification to the IP address translating module 52.

Finally, at step 303, since the stationary correspondent node 32 can receive packets having IPv6 addresses, the IP address translating module 52 does not intercept the IPv6 packet from the location supervising module 51, i.e., transmits it without modification to the stationary correspondent node 32.

A communication from the stationary correspondent node 32 to the mobile node 13 at the home network (link) 1 will be explained next with reference to FIG. 3B. Also, assume that an IPv6 address “A::a” is allocated as a home address to the mobile node 13 and an IPv6 address “X::c” is allocated to the stationary correspondent node 32.

First, at step 311, the stationary correspondent node 32 obtains the IPv6 address “A::a” of the mobile node 13 from the DNS server (not shown), and then transmits an IPv6 packet associated with an IPv6 header having a destination address “A::a” and a source address “X::c” to the IP address translating module 52.

Next, at step 312, since the IPv6 packet from the stationary correspondent node 32 does not need to translate its IP address, the IP address translating module 52 does not intercept the IPv6 packet, i.e., transmits it without modification to the location supervising module 51.

Finally, at step 313, the mobile node 13 remains in the home network (link) 1 so that the location supervising module 51 has no location relationship information of the mobile node 13, and the location supervising module 51 does not intercept the IPv6 packet from the stationary correspondent node 32, i.e., transmits it without modification to the mobile node 13.

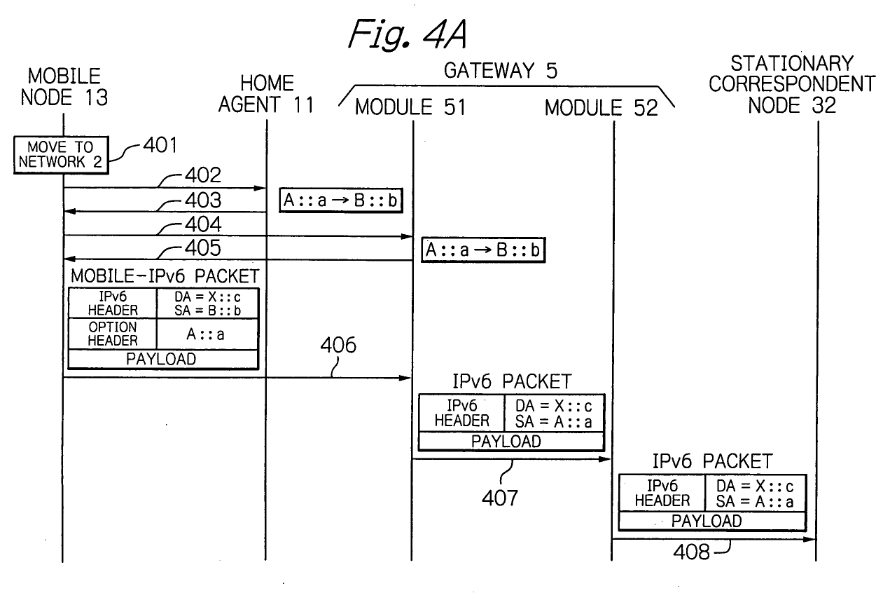

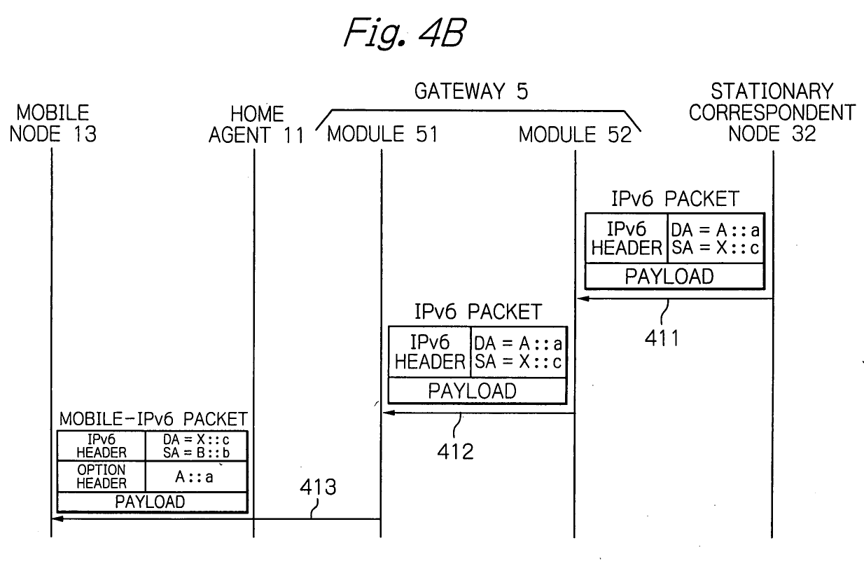

A communication from the mobile node 13 at the foreign network (link) 2 to the stationary correspondent node 32 will be explained next with reference to FIG. 4A. Here, assume that an IPv6 address “A::a” is allocated as a home address to the mobile node 13 and an IPv6 address “X::c” is allocated to-the stationary correspondent node 32.

First, at step 401, after the mobile node 13 is moved from the home network (link) 1 to the foreign network (link) 2, the mobile node 13 transmits a request for registering its current location which is, in this case, a care-of address “B::b” of the foreign network (link) 2 to the home agent 11. After the registration of the care-of-address “B::b” in the home agent 11, the home agent 11 transmits an acknowledgement of the registration to the mobile node 13, as indicated at step 403.

Next, at step 404, the mobile node 13 transmits a request for registering its current location which is, in this case, the care-of address “B::b” of the foreign network (link) 2 to the location supervising module 51. After the registration of the care-of address “B::b” in the location supervising module 51, the location supervising module 51 transmits an acknowledgement of the registration to the mobile node 13, as indicated at step 405.

Note that the operations as indicated at steps 404 and 405 are taken to realize security.

Next, at step 406, the mobile node 13 obtains the IPv6 address “X::c” of the stationary correspondent node 32 from the DNS server (not shown), and then transmits a Mobile-IPv6 packet associated with an IPv6 header having a destination address “X::c” and a source address “B::b” and a destination option header having a home address of “A::a” to the location supervising module 51.

Next, at step 407, the location supervising module 51 intercepts the Mobile-IPv6 packet from the mobile node 13, and encapsulates an IPv6 packet by replacing the source address with the home address of “A::a” and deleting the destination option header. Then, the location supervising module 51 transmits the IPv6 packet to the IP address translating module 52.

Finally, at step 408, since the stationary correspondent node 32 can receive packets having IPv6 addresses, the IP address translating module 52 does not intercept the IPv6 packet from the location supervising module 51, i.e., transmits it without modification to the stationary correspondent node 32.

A communication from the stationary correspondent node 32 to the mobile node 13 at the foreign network (link) 2 will be explained next with reference to FIG. 4B. Also, assume that an IPv6 address “A::a” is allocated as a home address to the mobile node 13 and an IPv6 address “X::c” is allocated to the stationary correspondent node 32.

First, at step 411, the stationary correspondent node 32 obtains the IPv6 address “A::a” of the mobile node 13 from the DNS server (not shown), and then transmits an IPv6 packet associated with an IPv6 header having a destination address “A::a” and a source address “X::c” to the IP address translating module 52.

Next, at step 412, since the IPv6 packet from the stationary correspondent node 32 does not need to translate its IP address, the IP address translating module 52 does not intercept the IPv6 packet, i.e., transmits it without modification to the location supervising module 51.

Finally, at step 413, the location supervising module 51 intercepts the IPv6 packet from the stationary correspondent node 32, and encapsulates a Mobile-IPv6 packet by replacing the source address with the care-of address of “B::b” and adding the destination option header having the home address of “A::a”. Then, the location supervising module 51 transmits the Mobile IPv6 packet to the mobile node 13.

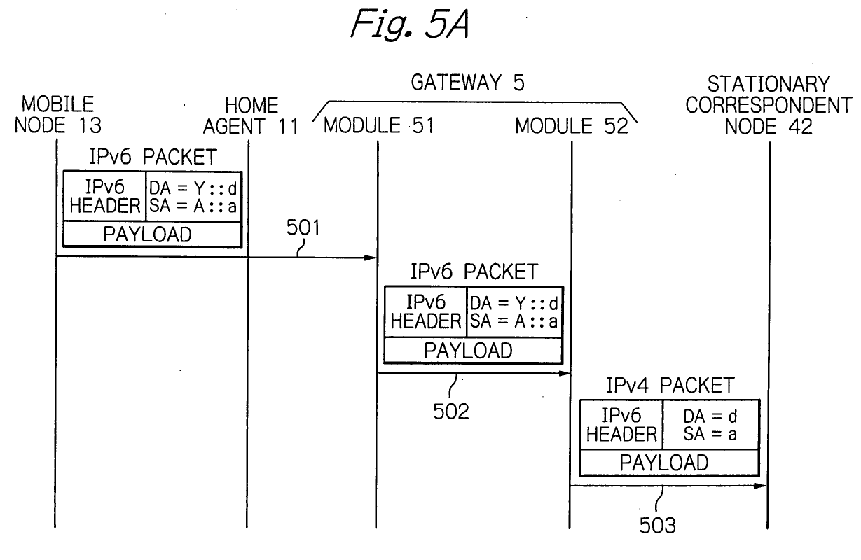

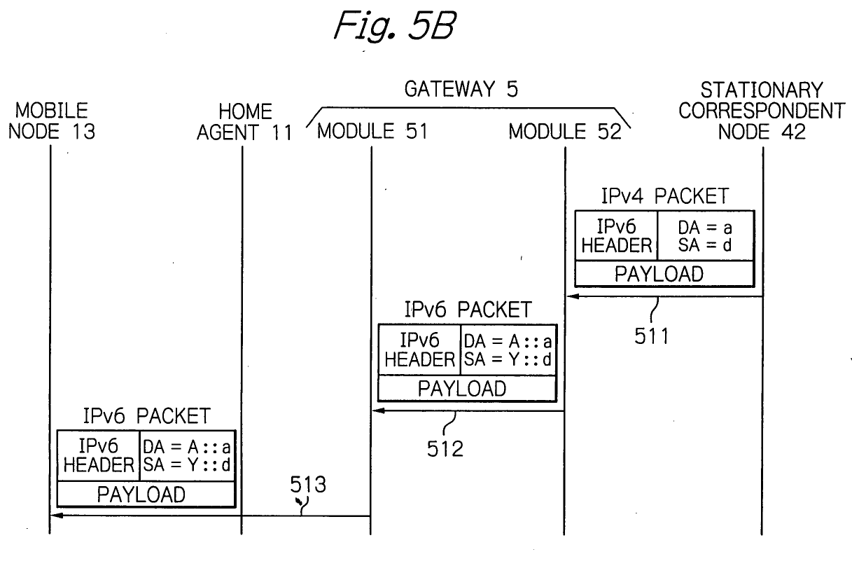

A communication from the mobile node 13 at the home network (link) 1 to the stationary correspondent node 42 will be explained next with reference to FIG. 5A. Here, assume that an IPv6 address “A::a” is allocated as a home address to the mobile node 13 and an IPv6 address “Y::d” and an IPv4 address “d” are allocated to the stationary correspondent node 42.

First, at step 501, the mobile node 13 obtains the IPv6 address “Y::d” of the stationary correspondent node 42 from the DNS server (not shown), and then transmits an IPv6 packet associated with an IPv6 header having a destination address “Y::d” and a source address'“A::a” to the location supervising module 51.

Next, at step 502, since the mobile node 13 remains in the home network (link) 1 so that the location supervising module 51 has no location relationship information of the mobile node 13, the location supervising module 51 does not intercept the IPv6 packet from the mobile node 13, i.e., transmits it without modification to the IP address translating module 52.

Finally, at step 503, since the stationary correspondent node 42 can receive only packets having IPv4 addresses, the IP address translating module 52 intercepts the IPv6 packet from the location supervising module 51, deletes the prefixes “Y” and “A” from the IPv6 header to encapsulate an IPv4 packet, and then, transmits it to the stationary correspondent node 42.

A communication from the stationary correspondent node 42 to the mobile node 13 at the home network (link) 1 will be explained next with reference to FIG. 5B. Also, assume that an IPv6 address “A::a” is allocated as a home address to the mobile node 13 and an IPv6 address “B::b” is allocated as a care-of address to the mobile node 13, and an IPv6 address “Y::d” and an IPv4 address “d” are allocated to the stationary correspondent node 42.

First, at step 511, the stationary correspondent node 42 obtains the IPv4 address “a” of the mobile node 13 from the DNS server (not shown), and then transmits an IPv4 packet associated with an IPv4 header having a destination address “a” and a source address “d” to the IP address translating module 52.

Next, at step 512, since the IPv4 packet from the stationary correspondent node 42 needs to translate its IP address, the IP address translating module 52 intercepts the IPv4 packet adds the prefixes “A” and “Y” to the destination address DA and the source address SA, respectively, to encapsulate an IPv6 packet, and then transmits it to the location supervising module 51.

Finally, at step 513, the mobile node 13 remains in the home network (link) 1 so that the location supervising module 51 has no location relationship information of the mobile node 13, and the location supervising module 51 does not intercept the IPv6 packet from the stationary correspondent node 32, i.e., transmits it without modification to the mobile node 13.

A communication from the mobile node 13 at the foreign network (link) 2 to the stationary correspondent node 42 will be explained next with reference to FIG. 5A. Here, assume that an IPv6 address “A::a” is allocated as a home address to the mobile node 13 and an IPv6 address “Y::d” and an IPv4 address “d” are allocated to the stationary correspondent node 42.

First, at step 601, after the mobile node 13 is moved from the home network (link) to the foreign network (link) 2, the mobile node 13 transmits a request for registering its current location which is, in this case, a care-of address “B::b” of the foreign network (link) 2 to the home agent 11. After the registration of the care-of-address “B::b” in the home agent 11, the home agent 11 transmits an acknowledgement of the registration to the mobile node 13, at step 603.

Next, at step 604, the mobile node 13 transmits a request for registering its current location which is, in this case, the care-of address “B::b” of the foreign network (link) 2 to the location supervising module 51. After the registration of the care-of address “B::b” in the location supervising module 51, the location supervising module 51 transmits an acknowledgement of the registration to the mobile node 13, at step 605.

Note that the operations at steps 604 and 605 are taken to realize security.

Next, at step 606, the mobile node 13 obtains the IPv6 address “Y::d” of the stationary correspondent node 42 from the DNS server (not shown), and then transmits a Mobile-IPv6 packet associated with an IPv6 header having a destination address “Y::d” and a source address “B::b” and a destination option header having a home address of “A::a” to the location supervising module 51.

Next, at step 607, the location supervising module 51 intercepts the Mobile-IPv6 packet from the mobile node 13, and encapsulates an IPv6 packet by replacing the source address with the home address of “A::a” and deleting the destination option header. Then, the location supervising module 51 transmits the IPv6 packet to the IP address translating module 52.

Finally, at step 608, since the stationary correspondent node 42 can receive only packets having IPv4 addresses, the IP address translating module 52 intercepts the IPv6 packet from the location supervising module 51, deletes the prefixes “Y” and “A” from the IPv6 header to encapsulate an IPv4 packet, and then, transmits it to the stationary correspondent node 42.

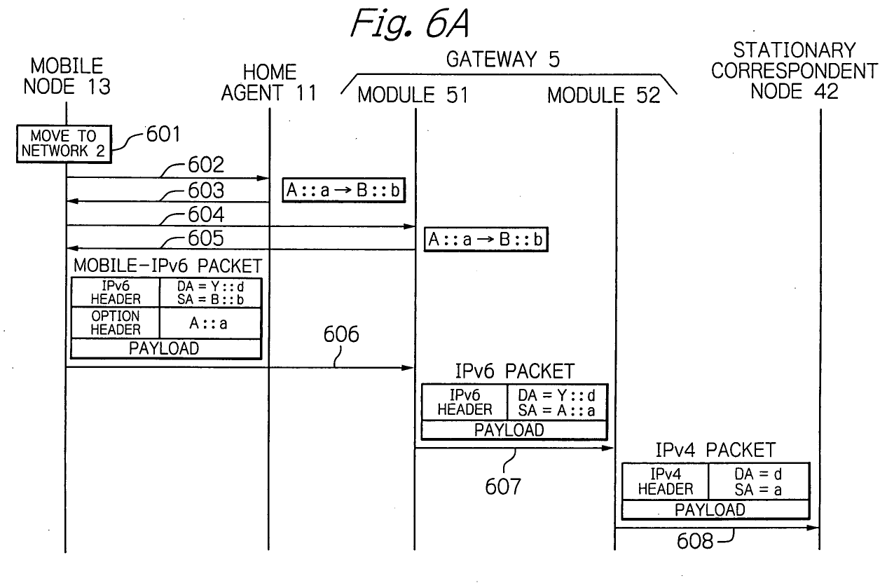

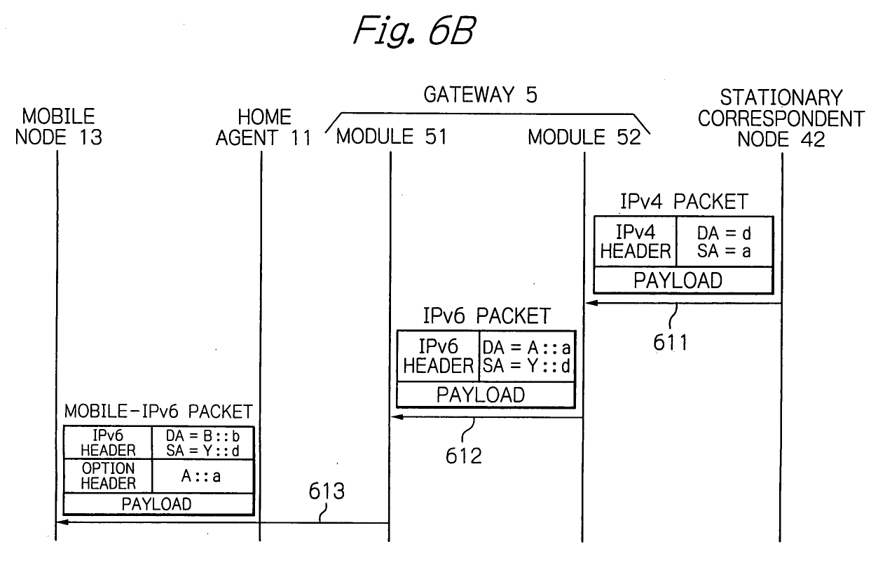

A communication from the stationary correspondent node 32 to the mobile node 13 at the foreign network (link) 2 will be explained next with reference to FIG. 6B. Also, assume that an IPv6 address “A::a” is allocated as a home address to the mobile node 13 and an IPv6 address “B::b” is allocated as a care-of address to the mobile node 13, and an IPv6 address “Y::d” and an IPv4 address “d” are allocated to the stationary correspondent node 42.

First, at step 611, the stationary correspondent node 42 obtains the IPv6 address “A::a” of the mobile node 13 from the DNS server (not shown), and then transmits an IPv6 packet associated with an IPv4 header having a destination address “a” and a source address “d” to the IP address translating module 52.

Next, at step 612, since the IPv4 packet from the stationary correspondent node 42 needs to translate its IP address, the IP address translating module 52 intercepts the IPv6 packet, adds the prefixes “A” and “Y” to the destination address DA and the source address SA, respectively, to encapsulate an IPv6 packet, and then, transmits it without modification to the location supervising module 51.

Finally, at step 613, the location supervising module 51 intercepts the IPv6 packet from the stationary correspondent node 42, and encapsulates a Mobile-IPv6 packet by replacing the source address with the care-of address of “B::b” and adding the destination option header having the home address of “A::a”. Then, the location supervising module 51 transmits the Mobile IPv6 packet to the mobile node 13.

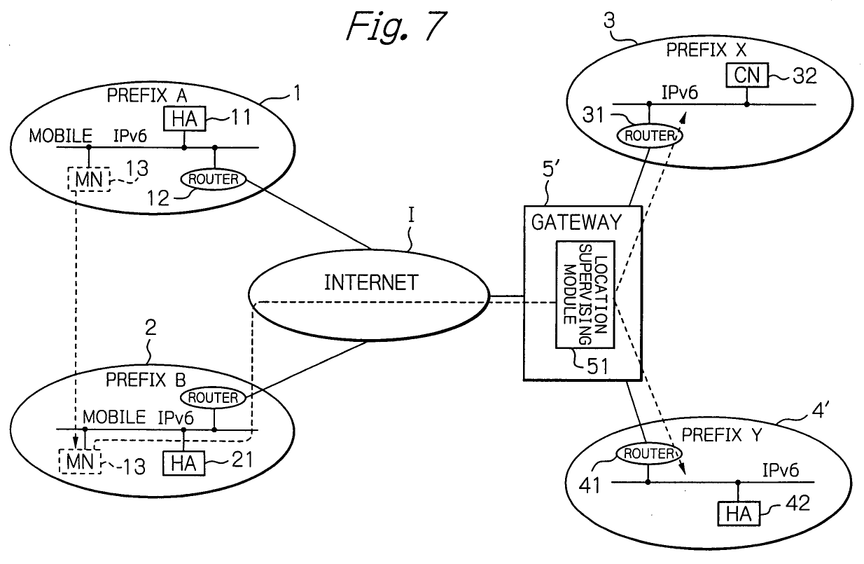

In the above-described embodiment, there are the IPv6 network (link) 3 and the IPv4 network (link)4. However, if no IPv4 networks (link) such as the IPv4 network (link) 4 are present, the IP address translating module 52 can be deleted as illustrated in FIG. 7 where the IPv4 network (link) 4 of FIG. 1 is replaced by an IPv6 network (link) 4′, because the IP address translating module 52 is present only for the IPv4 network (link) 4.

As explained hereinabove, according to the present invention, even when a Mobile-IPv6 mobile node is away from its home network (link) to a foreign network (link), a direct communication between the Mobile-IPv6 mobile node and a stationary correspondent node not implementing Mobile-IPv6 can be carried out without modifying the router of a network (link) to which the stationary correspondent node belongs.

1. A mobile communication system including a home Mobile-IPv6 network for allocating a home address as a permanent address to a mobile node, a foreign Mobile-IPv6 network for allocating a care-of address to said mobile node, and at least one network including a stationary correspondent node not implementing Mobile-IPv6, comprising:
a location supervising module for storing said home address and said care-of address of said mobile node when said mobile node is away from said home Mobile-IPv6 network and connected to said foreign Mobile-IPv6 network; and
an IP address translating module for translation of an IP address between IPv6 and a protocol other than IPv6.

2. The mobile communication system as set forth in claim 1, wherein, when said location supervising module receives an IPv6 packet transmitted from said mobile node at said home Mobile-IPv6 network to said stationary correspondent node, said location supervising module tunnels said IPv6 packet to said IP address translating module.

3. The mobile communication system as set forth in claim 1, wherein, when said location supervising module receives an IPv6 packet transmitted from said stationary correspondent node via said IP address translating module to said mobile node at said home MObile-IPv6 network, said location supervising module tunnels said IPv6 packet to said mobile node.

4. The mobile communication system as set forth in claim 1, wherein, when said location supervisory module receives a Movile-IPv6 packet transmitted from said mobile node at said foreign Mobile-IPv6 network via said IP address translating module to said stationary correspondent node, said location supervisory module intercepts said Mobile-IPv6 packet, encapsulates an IPv6 packet by replacing said care-of address as a source address with said home address in an option header of said Mobile-IPv6 packet and deleting said option header, and transmits said IPv6 packet to said IP address translating module.

5. The mobile communication system as set forth in claim 1, wherein, when said location supervisory module receives an IPv6 packet transmitted from said stationary correspondent node via said IP address translating module to said mobile node at said foreign Mobile-IPv6 network, said location supervisory module intercepts said IPv6 packet, encapsulates a Mobile-IPv6 packet by replacing said home address as a destination address with said care-of address and adding an option header including said home address, and transmits said Mobile-IPv6 packet to said mobile node.

6. The mobile communication system as set forth in claim 2, wherein said network not implementing Mobil-IPv6 implements IPv6, and
wherein, when said IP address translating module receives said IPv6 packet from said location supervising module, said IP address translating module tunnels said IPv6 packet to said stationary correspondent node.

7. The mobile communication system as set forth in claim 4, wherein said network not implementing Mobil-IPv6 implements IPv6, and
wherein, when said IP address translating module receives said IPv6 packet from said location supervising module, said IP address translating module tunnels said IPv6 packet to said stationary correspondent node.

8. The mobile communication system as set forth in claim 1, wherein said network not implementing Mobile-IPv6 implements IPv6, and
wherein, when said IP address receives an IPv6 packet from said stationary correspondent node, said IP address translating module tunnels said IPv6 packet to said location supervising module.

9. The mobile communication system as set forth in claim 2, wherein said network not implementing Mobile-IPv6 implements IPv4, and
wherein, when said IP address translating module receives said IPv6 packet from said location supervising module, said IP address translating module intercepts said IPv6 packet, encapsulates an IPv4 packet by deleting prefixes of a destination address and a source address of said IPv6 packet, and transmits said IPv4 packet to said stationary correspondent node.

10. The mobile communication system as set forth in claim 4, wherein said network not implementing Mobile-IPv6 implements IPv4, and
wherein, when said IP address translating module receives said IPv6 packet from said location supervising module, said IP address translating module intercepts said IPv6 packet, encapsulates an IPv4 packet by deleting prefixes of a destination address and a source address of said IPv6 packet, and transmits said IPv4 packet to said stationary correspondent node.

11. The mobile communication system as set forth in claim 1, wherein said network not implementing Mobil-IPv6 implements IPv4, and
wherein, when said IP address translating module receives an IPv4 packet from said stationary correspondent node, said IP address translating module intercepts said IPv4 packet, encapsulates an IPv6 packet by adding prefixes to a destination address and a source address of said IPv4 packet, and transmits said IPv6 packet to said location supervising module.

12. The mobile communication system as set forth in claim 1, further comprising a gateway including said location supervising module and said IP address translating module.

13. The mobile communication system as set forth in claim 12, wherein said home Mobile-IPv6 network and said foreign Mobile-IPv6 network are connected to the Internet, and said network not implementing Mobile-IPv6 is connected via said gateway to the Internet.

14. A mobile communication system including a home Mobile-IPv6 network for allocating a home address as a permanent address to a mobile node, a foreign Mobile-IPv6 network for allocating a care-of address to said mobile node, and at least one IPv6 network including a stationary correspondent node, comprising a location supervising module for storing said home address and said care-of address of said mobile node when said mobile node is away from said home Mobile-IPv6 network and connected to said foreign Mobile-IPv6 network.

15. The mobile communication system as set forth in claim 14, wherein, when said location supervising module receives an IPv6 packet transmitted from said mobile node at said home Mobile-IPv6 network to said stationary correspondent node, said location supervising module tunnels said IPv6 packet to said stationary correspondent node.

16. The mobile communication system as set forth in claim 14, wherein, when said location supervising module receives an IPv6 packet transmitted from said stationary correspondent node to said mobile node at said home MObile-IPv6 network, said location supervising module tunnels said IPv6 packet to said stationary correspondent node.

17. The mobile communication system as set forth in claim 14, wherein, when said location supervisory module receives a Movile-IPv6 packet transmitted from said mobile node at said foreign Mobile-IPv6 network to said stationary correspondent node, said location supervisory module intercepts said Mobile-IPv6 packet, encapsulates an IPv6 packet by replacing said care-of address as a source address with said home address in an option header of said Mobile-IPv6 packet and deleting said option header, and transmits said IPv6 packet to said stationary correspondent node.

18. The mobile communication system as set forth in claim 14, wherein, when said location supervisory module receives an IPv6 packet transmitted from said stationary correspondent node to said mobile node at said foreign Mobile-IPv6 network, said location supervisory module intercepts said IPv6 packet, encapsulates a Mobile-IPv6 packet by replacing said home address as a destination address with said care-of address and adding an option header including said home address, and transmits said Mobile-IPv6 packet to said mobile node.

19. The mobile communication system as set forth in claim 14, further comprising a gateway including said location supervising module.

20. The mobile communication system as set forth in claim 19, wherein said home Mobile-IPv6 network and said foreign Mobile-IPv6 network are connected to the Internet, and said IPv6 network is connected via said gateway to the Internet.

21. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, a location supervising module for storing said home address and said care-of address of said mobile node when said mobile node is away from said home Mobile-IPv6 network and connected to said foreign Mobile-IPv6 network, and an IP address translating module for translation of an IP address between IPv6 and a protocol other than IPv6, an IPv6 packet being transmitted from said mobile node at said home Mobile-IPv6 network to said stationary correspondent node,
said method comprising:
tunneling said IPv6 packet without intercepting said IPv6 packet by said location supervising module to said IP address translating module; and
tunneling said IPv6 packet from said location supervising module without intersecting said IPv6 packet by said IP address translating module to said stationary correspondent node.

22. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, a location supervising module for storing said home address and-said care-of address of said mobile node when said mobile node is away from said home Mobile-IPv6 network to said foreign Mobile-IPv6 network, and an IP address translating module for translation of an IP address between IPv6 and a protocol other than IPv6, an IPv6 packet being transmitted from said stationary correspondent node to said mobile node at said home Mobile-IPv6 network,
said method comprising:
tunneling said IPv6 packet without intercepting said IPv6 packet by said IP address translating module to said location supervising module; and
tunneling said IPv6 packet from said IP address translating module without intercepting said IPv6 packet by said location supervising module to said mobile node.

23. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, a location supervising module for storing said home address and said care-of address of said mobile node when said mobile node is away from said home Mobile-IPv6 network to said foreign Mobile-IPv6 network, and an IP address translating module for translation of an IP address between IPv6 and a protocol other than IPv6, a Mobile-IPv6 packet being transmitted from said mobile node at said foreign Mobile-IPv6 network to said stationary correspondent node,
said method comprising:
intercepting said Mobile-IPv6 packet by said location supervisory module;
encapsulating an IPv6 packet by replacing said care-of address as a source address with said home address in an option header of said Mobile-IPv6 packet and deleting said option header by said location supervising module;
transmitting said IPv6 packet by said location supervising module to said IP address translating module; and
tunneling said IPv6 packet from said location supervising module without intercepting said IPv6 packet by said IP address translating module to said stationary correspondent node.

24. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, a location supervising module for storing said home address and said care-of address of said mobile node when said mobile node is away from said home Mobile-IPv6 network to said foreign Mobile-IPv6 network, and an IP address translating module for translating an IP address between IPv6 and a protocol other than IPv6, an IPv6 packet being transmitted from said stationary correspondent node to said mobile node at said foreign Mobile-IPv6 network,
said method-comprising:
tunneling said IPv6 packet without intercepting said IPv6 packet by said IP address translating module to said location supervising module;
intercepting said IPv6 packet by said location supervising module;
encapsulating a Mobile-IPv6 packet by replacing said home address as a destination address with said care-of address and adding an option header including said home address by said location supervising module; and
transmitting said Mobile-IPv6 packet to said mobile node.

25. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, and a location supervising module for storing said home address and said care-of address of said mobile node when said mobile node is away from said home Mobile-IPv6 network to said foreign Mobile-IPv6 network, an IPv6 packet being transmitted from said mobile node at said home Mobile-IPv6 network to said stationary correspondent node,
said method comprising:
tunneling said IPv6 packet without intercepting said IPv6 packet by said location supervising module to said stationary correspondent node.

26. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, and a location supervising module for storing said home address and said care-of address of said mobile node when said mobile node is away from said home Mobile-IPv6 network to said foreign Mobile-IPv6 network, an IPv6 packet being transmitted from said stationary correspondent node to said mobile node at said home Mobile-IPv6 network,
said method comprising:
tunneling said IPv6 packet without intercepting said IPv6 packet by said IP address translating module to said mobile node.

27. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, and a location supervising module for storing said home address and said care-of address of said mobile node when said mobile node is away from said home Mobile-IPv6 network to said foreign Mobile-IPv6 network, a Mobile-IPv6 packet being transmitted from said mobile node at said foreign Mobile-IPv6 network to said stationary correspondent node,
said method comprising:
intercepting said Mobile-IPv6 packet by said location supervisory module;
encapsulating an IPv6 packet by replacing said care-of address as a source address with said home address in an option header of said Mobile-IPv6 packet and deleting said option header by said location supervising module; and
transmitting said IPv6 packet by said location supervising module to said stationary correspondent node.

28. A shortest communications path method for a mobile communication system including a home Mobile-IPv6 network for allocating a home address as a permanent address to a mobile node, a foreign Mobile-IPv6 network for allocating a care-of address to said mobile node, at least one IPv6 network including a stationary correspondent node, and a location supervising module for storing said home address and said care-of address of said mobile node when said mobile node is away from said home Mobile-IPv6 network to said foreign Mobile-IPv6 network, an IPv6 packet being transmitted from said stationary correspondent node to said mobile node at said foreign Mobile-IPv6 network,
said method comprising:
intercepting said IPv6 packet by said location supervising module;
encapsulating a Mobile-IPv6 packet by replacing said home address as a destination address with said care-of address and adding an option header including said home address by said location supervising module; and
transmitting said Mobile-IPv6 packet to said mobile node.

29. A shortest communications path method for a mobile communication system including a home Mobile-IPv6 network for allocating a home address as a permanent address to a mobile node, a foreign Mobile-IPv6 network for allocating a care-of address to said mobile node, at least one IPv4 network including a stationary correspondent node a location supervising module for storing said home address and said care-of address of said mobile node when said mobile node is away from said home Mobile-IPv6 network to said foreign Mobile-IPv6 network, and an IP address translating module for translation of an IP address between IPv6 and a protocol other than IPv6, an IPv6 packet being transmitted from said mobile node at said home Mobile-IPv6 network to said stationary correspondent node,
said method comprising:
tunneling said IPv6 packet without intercepting said IPv6 packet by said location supervising module to said IP address translating module;
intercepting said IPv6 packet from said location supervising module by said IP address translating module;
encapsulating an IPv4 packet by deleting prefixes of a destination address and a source address of said IPv6 packet by said IP address translating module; and
transmitting said IPv4 packet by said IP address translating module to said stationary correspondent node.

30. A shortest communications path method for a mobile communication system including a home Mobile-IPv6 network for allocating a home address as a permanent address to a mobile node, a foreign Mobile-IPv6 network for allocating a care-of address to said mobile node, at least one IPv4 network including a stationary correspondent node, a location supervising module for storing said home address and said care-of address of said mobile node when said mobile node is away from said home Mobile-IPv6 network to said foreign Mobile-IPv6 network, and an IP address translating module for translation of an IP address between IPv6 and a protocol other than IPv6, an IPv4 packet being transmitted from said stationary correspondent node to said mobile node at said home Mobile-IPv6 network,
said method comprising:
intercepting said IPv4 packet by said IP address translating module;
encapsulating an IPv6 packet by adding prefixes to a destination address and a source address of said IPv4 packet by said IP address translating module;
transmitting said IPv6 packet by said IP address translating module to said location supervising module; and
tunneling said IPv6 packet from said IP address translating module without intercepting said IPv6 packet by said location supervising module to said mobile node.

31. A shortest communications path method for a mobile communication system including a home Mobile-IPv6 network for allocating a home address as a permanent address to a mobile node, a foreign Mobile-IPv6 network for allocating a care-of address to said mobile node, at least one IPv4 network including a stationary correspondent node, a location supervising module for storing said home address and said care-of address of said mobile node when said mobile node is away from said home Mobile-IPv6 network to said foreign Mobile-IPv6 network, and an IP address translating module for translation of an IP address between IPv6 and a protocol other than IPv6, a-Mobile-IPv6 packet being transmitted from said mobile node at said foreign Mobile-IPv6 network to said stationary correspondent node,
said method comprising:
intercepting said Mobile-IPv6 packet by said location supervisory module;
encapsulating an IPv6 packet by replacing said care-of address as a source address with said home address in an option header of said Mobile-IPv6 packet and deleting said option header by said location supervising module;
transmitting said IPv6 packet by said location supervising module to said IP address translating module;
intercepting said IPv6 packet by said IP address translating module;
encapsulating an IPv4 packet by deleting prefixes of a destination address and a source address of said IPv6 packet by said IP address translating module; and
transmitting said IPv4 packet by said IP address translating module to said stationary correspondent node.

32. A shortest communications path method for a mobile communication system including a home Mobile-IPv6 network for allocating a home address as a permanent address to a mobile node, a foreign Mobile-IPv6 network for allocating a care-of address to said mobile node, at least one IPv4 network including a stationary correspondent node, a location supervising module for storing said home address and said care-of address of said mobile node when said mobile node is away from said home Mobile-IPv6 network to said foreign Mobile-IPv6 network, and an IP address translating module for translating an IP address between IPv6 and a protocol other than IPv6, an IPv6 packet being transmitted from said stationary correspondent node to said mobile node at said foreign Mobile-IPv6 network,
said method comprising:
intercepting said IPv4 packet by said IP address translating module;
encapsulating an IPv6 packet by adding prefixes to a destination address and a source address of said IPv4 package by said IP address translating module;
transmitting said IPv6 packet to said location supervising module;
intercepting said IPv6 packet by said location supervising module;
encapsulating a Mobile-IPv6 packet by replacing said home address as a destination address with said care-of address and adding an option header including said home address by said location supervising module; and
transmitting said Mobile-IPv6 packet to said mobile node.
